(19) United States
(12) Patent Application Publication
(10) Pub. No.: US 2020/0365169 A1
(43) Pub. Date: Nov. 19, 2020

(54) SYSTEM FOR DEVICE-AGNOSTIC SYNCHRONIZATION OF AUDIO AND ACTION OUTPUT

(71) Applicant: SoundHound, Inc., Santa Clara, CA (US)

(72) Inventors: Mara Selvaggi, Santa Clara, CA (US); Rainer Leeb, San Jose, CA (US)

(73) Assignee: SoundHound, Inc., Santa Clara, CA (US)

(21) Appl. No.: 16/410,826

(22) Filed: May 13, 2019

(51) Int. Cl. G10L 21/055; G10L 13/00; G10L 25/63; G06F 3/01

(52) U.S. Cl. CPC G10L 21/055; G10L 13/00; G06F 3/017; G06F 3/011; G10L 25/63

(57) ABSTRACT

A system and method are disclosed for device-agnostic synchronizing of audio and physical actions at a client device. Different client devices may synthesize audio from text at different rates, and different client devices may perform physical actions such as gestures and other physical movements at different rates. The system of the present technology enables synchronization of audio with physical actions at different client devices, where audio and/or physical actions may be synthesized at different rates.

### FIELD

The present technology relates to synchronization of audio and physical actions at a client device, and in particular to a system capable of synchronizing audio with variable-duration actions performed at different client devices.

### BACKGROUND

Humans express themselves not just with speech, but also with physical gestures such as facial expressions and hand or other body movements. When speech is synthesized at a client output device, it may therefore be desirable to synchronize the speech with gestures and/or other physical actions to more closely emulate genuine human expression. Such client devices may include computer-controlled graphical user interfaces, for example displaying an avatar or animated character speaking and performing an accompanying action. Such client devices may also include computer-controlled mechanical devices, such as for example a robot speaking and performing an accompanying action.

The synchronization of audio with actions is known where the developer defining the audio and physical actions also provides or controls the output client devices. However, there is at present no known solution to synchronizing audio with physical actions at different client devices where the domain developer defining the audio and actions has no control over the client devices. For example, different client devices perform physical actions at different speeds, depending for example on how fast the mechanical features of the device can move. There is a need for a system where domain developers can provide syntax for synchronizing audio with actions at an unknown set of different client devices.

### DESCRIPTION OF THE DRAWINGS

FIG. 1 is a schematic representation of an operating environment of embodiments of the present technology.

FIG. 2 is a flowchart of a general overview of the operation of a platform for receiving audio requests for information and providing information responsive to the requests.

FIG. 3 is a schematic block diagram of a general overview of the operation of a platform for receiving audio requests for information and providing information responsive to the requests.

FIG. 4 is a flowchart implemented by a domain developer for synchronizing audio and physical actions at different client devices according to embodiments of the present technology.

FIG. 5 is a flowchart implemented by a client device developer for synchronizing audio and physical actions at a client device according to embodiments of the present technology.

FIG. 6 is a flowchart implemented by a client device developer for synchronizing audio and physical actions at a client device according to an alternative embodiment of the present technology.

FIG. 7 is a flowchart illustrating further details of step 212 in FIG. 2 of generating a response to be sent to a client device including audio and action commands according to embodiments of the present technology.

FIG. 8A is a perspective view of a mechanical device synchronizing speech and physical actions according to embodiments of the present technology.

FIG. 8B is a perspective view of a mechanical device synchronizing speech and physical actions according to embodiments of the present technology.

FIG. 9 is a schematic block diagram of a computing environment according to embodiments of the present technology.

### DETAILED DESCRIPTION

The present technology will now be described with reference to the figures, which in embodiments, relate to a system capable of synchronizing synthesized audio and physical actions at a client device for example to more closely emulate human expression. In embodiments, the synchronization system of the present technology is device-agnostic. Specifically, different client devices may synthesize audio from text at different rates, and different client devices may perform physical actions such as gestures and other physical movements at different rates. The system of the present technology enables synchronization of audio with physical actions at different client devices, where audio and/or physical actions may be synthesized at different rates.

In embodiments, the code for synchronizing audio with physical actions is provided by a domain developer without specific knowledge of the audio and action timing parameters of client devices which will output the audio and actions. The domain developer may generate a first stream including text statements that get synthesized to speech or audio at a client device. The domain developer may also generate a second stream including action or movement statements or commands linked to at least some of the text statements. The domain developer may interleave stream code or one stream within another such as by embedding action statements within the text statement stream.

The movement commands may include code defining the one or more physical actions to be performed at the client device in synchronization with the associated audio. The domain developer may further define the manner in which the audio is to be synchronized with the physical movement at the client device. Examples of such definitions include synchronizing the audio and physical actions to begin at the same time, to end at the same time and/or to begin and end at the same time. The domain developer may further provide definitions for localized gestures (i.e., definitions enabling the selection of one of different gestures associated with the same audio, depending on the locality of the client device), and definitions for mood-dependent gestures (i.e., definitions enabling the selection of one of different gestures associated with the same audio, depending on the mood at the locality of the client device).

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

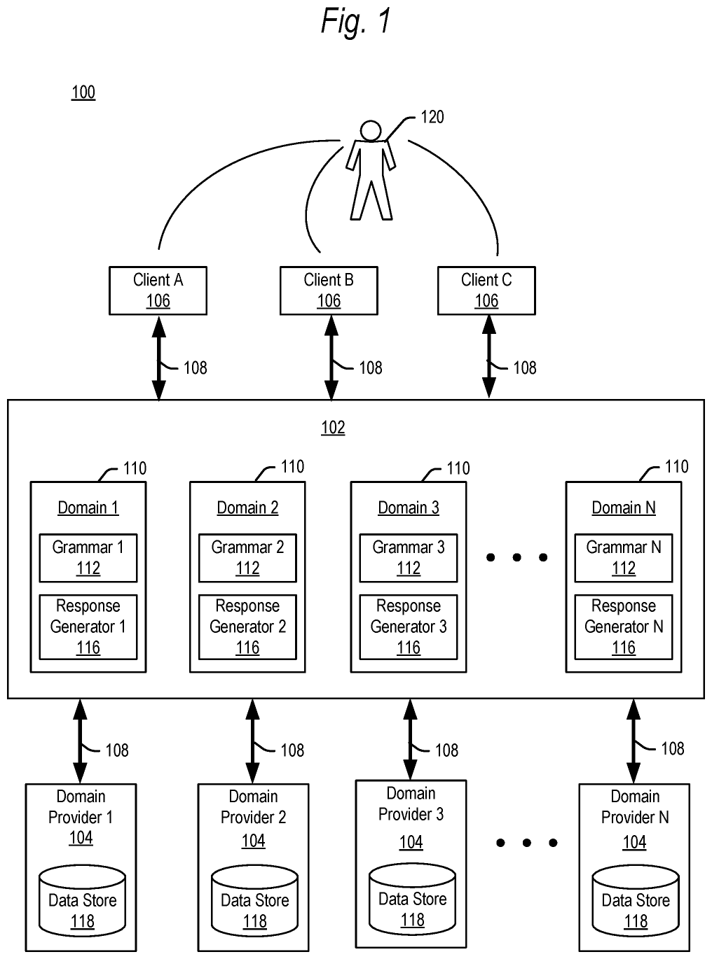

FIG. 1 is a schematic representation of an environment 100 in which the present technology may be implemented. The environment 100 includes a platform 102 comprising one or more servers in communication with a number of domain providers 104, and one or more client devices 106 operated by user 120. The number of domain providers 104 may be any number, N, of domain providers. The number of client devices 106 may also vary in further embodiments beyond that shown in FIG. 1. The platform 102 may communicate with the domain providers 104 and client devices 106 via a network 108 (indicated by arrows). Network 108 may for example be the Internet, but a wide variety of other wired and/or wireless communication networks are possible, including for example cellular telephone networks.

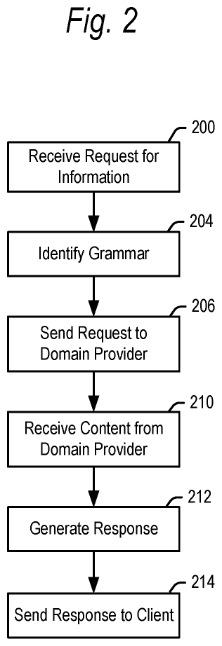

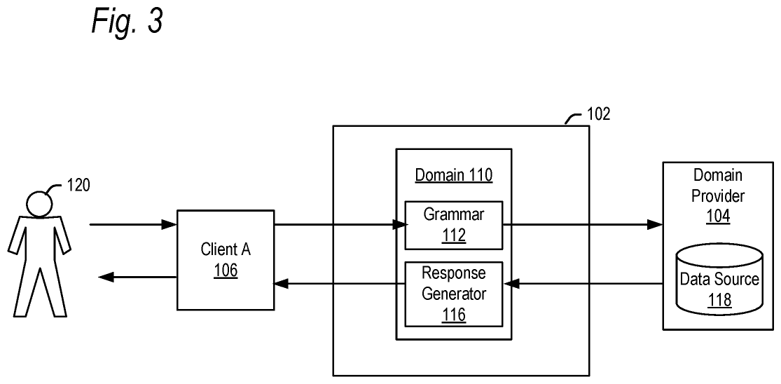

Domain providers 104 may generate and upload domains 110 to the one or more servers of the platform 102, thereby enabling the domain providers to be a source of information to the user 120. Each domain 110 may comprise a grammar 112 and a response generator 116. Further details of a grammar 112 and response generator 116 of a domain 110 will now be explained with reference to the flowchart and schematic block diagram of FIGS. 2 and 3. In step 200, the platform 102 receives an audio request for information from the user 120 via one of the client devices 106.

Although not part of the present technology, the audio request may be digitized and, for example, processed by a speech recognition algorithm into text hypotheses representing the received audio request. The text hypotheses may next be compared to the grammars 112 of the various domains 110 in step 204 to find a match in order to determine which domain is most likely to have information responsive to the audio request. In general, a domain provider 104 provides a grammar 112 to platform 102 to determine when a user is requesting information of the type provided by that domain provider 104.

Once a match to a grammar 112 is identified in step 204, the platform 102 sends the digitized request for information in step 206 to the domain provider 104 associated with the identified grammar 112. Domain providers 104 may include data stores 118 for storing content related to a particular topic or topics. Domain providers 104 may store content related to any known topic such as for example current events, sports, politics, science and technology, entertainment, history, travel, geography, hobbies, weather, social networking, recommendations, home and automobile systems and/or a wide variety of other topics.

The domain provider 104 may process the request and return content fulfilling the request to its domain 110 on the platform 102 in step 210. The content may be processed into a response in response generator 116 in step 212. In accordance with aspects of the present technology, the response generator 116 may process a response to audio and an associated physical action to be output/performed by the client device 106. These features are described in greater detail below. The response including audio and, possibly, physical actions to be synchronized with the audio, are then sent to the client in step 214 which then outputs the audio and, if applicable, performs the associated physical action.

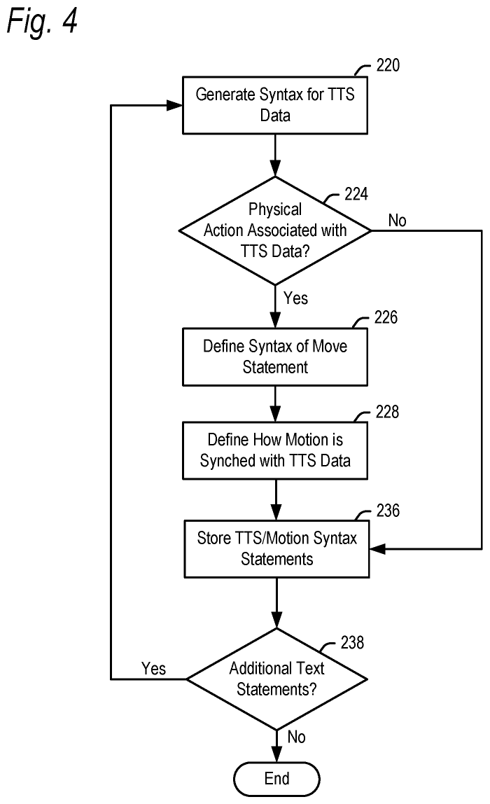

As mentioned above, each domain provider 104 creates a domain 110, including the response generator 116, and uploads it to platform 102. Further details regarding the creation of the response generator 116 by a software developer associated with the domain provider 104 will now be explained with reference to the flowchart of FIG. 4. In general, the response generator 116 may comprise one or more software algorithms receiving content, data and/or instructions from its corresponding domain provider 104, and thereafter generating text-to-speech (TTS) data, and, possibly, action commands that get sent to a client device. As explained below, the one or more algorithms of the response generator 116 also define a manner in which TTS data is synchronized to action commands.

In step 220, the domain provider may generate software code including the syntax for handling TTS data. In an example syntax, <tts> and </tts> delimit text for speech synthesis. Thus, the syntax:

<tts>hello</tts>

would result in the client device speaking the word “hello”. The TTS data syntax statement may optionally use Speech Synthesis Markup Language (SSML) coding, which may include TTS data, as well as emphasis and prosody data with respect to how the data is spoken when synthesized into speech.

As noted, in accordance with the present technology, response generator 116 may further generate physical actions to be performed at the client device in synchronization with the synthesized speech. In one example, the physical actions may define any of a wide variety of gestures, facial expressions and/or other body movements to be performed at or by the client device 106. In embodiments, the client device 106 may be a computing device including a graphical user interface. In such embodiments, the graphical user interface may display an avatar or other animated character performing the specified physical actions. In further embodiments, the client device may be a robot including features emulating at least portions of a human physical form. These features may for example include at least one of movable limbs, a head and movable facial features. In such embodiments, the robot may perform the specified physical actions. As one simple example of these embodiments, the response generator 116 may include a physical action resulting in a hand wave, synchronized to the word hello, performed by the graphical character or physical robot.

It is understood that the actions accompanying the synthesized speech need not relate to a human performing gestures or other body movements. The client device 106 may be a household appliance, automobile, or a wide variety of other devices in which physical actions can accompany synthesized speech. As one simple example of this embodiment, the response generator 116 may include the physical action of raising the windows of an automobile while the words “windows up” are played over the car audio system.

It may be that only some TTS data has associated physical action commands. Referring again to the flowchart of FIG. 4, if there is no physical action associated with a TTS data syntax statement, at step 224, the flow may skip to step 236 of simply storing the created TTS data syntax statement. On the other hand, if some physical action is to be associated with the synthesized speech defined in a TTS data syntax statement, those physical actions, and the manner in which they are synchronized with the TTS data, are specified by the domain provider 104 in steps 226 and 228.

In particular, in step 226 the domain provider may generate software code including the syntax for handling action commands. In an example syntax, <move> and </move> delimit some action to be performed at the output device. The function for the <move> statement may be broad, subsuming a number of physical movements under a single function call. For example, the syntax:

<move>wave(2)</move>

would result in a client device character/robot waving for 2 seconds. Alternatively, function for the <move> statement may be detailed. For example syntax for a client device wave may include the following:

```
<move>
  shoulder(ω,θ,φ)
  elbow(ω,θ,φ)
  wrist(+/−30°,θ,φ,2)
  fingers(ω,θ,φ)
</move>
```

The above <move> statements specify the positions of the shoulder, elbow, wrist and fingers in performing a wave (using angular coordinates in three dimensions, which coordinates could be specified with real values in the actual <move> statements), as well as the rotation of the wrist about one axis for the duration of two seconds. The function need not require angular coordinates in three dimensions in further embodiments. Moreover, it is understood that function calls may be written to specify and support any of a wide variety of physical movements and actions.

In step 228, the software developer for the domain publisher may define how the <TTS> and the <move> statements are synchronized with each other. As noted above, outputting synthesized speech takes a variable amount of time, depending on what the phrase is and SSML prosody markup codes. The amount of time to speak a phrase can also be device-specific, depending on the installed TTS voice. At the same time, performing an action command takes a variable amount of time, depending on what the movement is and the parameters of the client device. Generally, physical movements depicted on a display have no limitations as to speed of the movements, but physical movements performed by robots or other mechanical devices depend on parameters of the devices. These movements will often be device-specific, varying from device to device, based on parameters such as the power of motors performing the movements, the weight of the physical components, the starting and ending positions of the motors, etc.

In accordance with aspects of the present technology, the software developer for the domain publisher may further include a <sync X> tag in the <TTS> and the <move> statements. This tag links (synchronizes) a given <TTS> statement with a given <move> statement, as well as defining the nature of the synchronization. For example, a <sync X> tag may specify that a given set of spoken words are to start at the same time as a given set of actions.

For example, a function salute ( ) may be defined that extends the finger joints of an android and uses the elbow and shoulder joints to raise the hand to an eyebrow over about 0.4 seconds, and another function at_ease ( ) may be defined that lowers the hand, over 0.3 seconds. Thus, in one example, the domain provider may define the following:

<tts> <sync 001>yes sir </tts>
<move> <sync 001>salute( );at_ease( )</move>.

The statements are linked to each other by the same tag designation (001). The statements will be synchronized to begin at the same time. Thus, the client device will speak the words “yes sir” at the same time the client device performs the action of saluting and returning to the at ease position. The audio and actions may end at different times. For example, the arm will reach the top of its salute at 0.4 seconds and begin its at ease motion. The speech will finish at about 0.5 seconds, and the arm will reach the bottom of its at-ease position at 0.7 seconds.

It may be desirable to control the relative timing at which the words are spoken and the action is performed. Thus, in a further example, the syntax may be:

<tts> <sync 002>yes <sync 003>sir </tts>
<move> <sync 002>salute( ) <sync 003>at_ease( )</move>

The “yes” TTS statement is linked to the salute action, and the “sir” TTS statement is linked to the at ease action. Thus, the client device will start the spoken word “yes” at the same time the salute begins, and the client device will start the spoken word “sir” at the same time the at ease begins. In this example, the robot finishes the word “yes” at 0.25 seconds and remains silent until the arm reaches the top of its salute at 0.4 seconds. Then, the robot begins lowering its arm while saying “sir”. It finishes the speech after 0.25 seconds and the arm reaches the bottom of its at-ease position after 0.3 seconds.

It may be desirable to control the relative timing at which the words are spoken and the action is performed to begin and end at the same time. This may be accomplished with a slow synchronization <slync X> tag. It causes text and action commands to start and complete at the same time by intentionally slowing whichever is faster.

<tts> <sync 004>yes sir <slync 005></tts>
<move><sync 004>salute( );at ease( )<slync 005></move>

In this example, the TTS for “yes sir” takes about 0.5 seconds and the android arm motions take about 0.7 seconds. Thus, the slow synchronization statement will cause the device to slow its TTS output to take 0.7 seconds.

The following is a further example of the slow synchronization operating to slow the specified movement:

<tts> <sync 006>yes sir I understand what you said and I will
carry out your order exactly<slync 007></tts>
<move><sync 006>salute( );at_ease( )<slync 007></move>

In this example, normal TTS would take more than 5 seconds. The <slync 007> tag for the <move> stream would make the motions slow such that it ends simultaneously with the TTS.

It may be desirable to control the relative timing at which the words are spoken and the action is performed to possibly start at different times, but to end at the same time. This may be accomplished with an end synchronization <lyncend X> tag. It causes text and action commands to start at such a time so as to complete at the same time.

<tts> <sync 006>yes sir <lyncend 007></tts>
<move><sync 006>salute( );at_ease( )<lyncend 007></move>

In this example, the TTS for “yes sir” takes about 0.5 seconds and the android arm motions take about 0.7 seconds. Thus, the end synchronization statement will cause the device to delay its TTS output for 0.2 seconds after the start of the motions so that the TTS and motions end at the same time.

It is further possible to combine the above tags and/or coding method to allow the domain provider to further control the manner in which the audio and movements are synchronized to each other. As an example, the software developer may choose to slow synchronize a first word of a phrase with a first movement, and a separate slow synchronize for a second word in a phrase with a second movement:

<tts><sync 008>yes <slync 009>sir <slync 010></tts>
<move><sync 008>salute( )<slync009>at_ease( )<slync 010></move>

It is understood that a wide variety of other tags and coding examples may be used to control how audio is synchronized to movements.

As described hereinafter, when a formatted response is sent by the response generator 116 to the client device 106, the data may be sent in two streams. The first stream may include TTS data syntax statements, and the second stream may include the action command syntax statements. As noted, linked statements may be recognized as a result of the tags used within the statements.

In embodiments, when a given set of one or more actions are linked with TTS data as described above, those actions will be performed whenever the TTS data is synthesized into speech. However, in further embodiments, syntax statements may further include a classifier which allows certain designated speech to have more than one linked action, or alternatively which allows certain designated actions to have more than one linked speech. This classifier is useful for example when coding for different languages. For example, certain phrases may have one commonly associated gesture in one country, but an entirely different commonly associated gesture in another country. In the United States, it is common to wave at someone when saying hello, while in Japan, it is common to bow to someone when saying hello. In embodiments, it is possible to add a locality tag as a classifier in linked syntax statements such that the proper gesture or physical action will be performed with an utterance, depending upon the locality of the client device.

<tts> <locality 001> <sync 001>hello </tts>
<move> <locality 001> <sync 001>wave( )</move>
<tts> <locality 002> <sync 001>hello </tts>
<move> <locality 002> <sync 001>bow( )</move>

In this embodiment, as explained below, as the client device is to speak the utterance, it first determines its locality, and then performs the action appropriate to that locality. In this example, the locality 001 may be in the United States, and the locality 002 may be in Japan.

Another example of a classifier which may be used is mood. Some gestures may appropriately accompany a spoken utterance when the mood of a room or environment is happy, whereas these gestures would be inappropriate to accompany a spoken utterance when the mood of the room or environment is sad.

<tts> <mood 001> <sync 001>hello </tts>
<move> <mood 001> <sync 001>wave( )</move>
<tts> <mood 002> <sync 001>hello </tts>
<move> <mood 002> <sync 001>smile( )</move>

In this embodiment, as explained below, as the client device is to speak the utterance, it first determines a mood, and then performs the action appropriate to that mood. In this example, the mood 001 may be for a happy occasion, and the mood 002 may be for a sad occasion.

Once a software developer has defined the syntax statements, synchronization tags and/or classification tags for the TTS data and action commands, the syntax statements may be stored in step 236. If there are additional statements to code in step 238, the above-described definition processes may repeat. If not, the flow ends. The steps of FIG. 4 may be performed by software developers for each domain provider 104 to generate the code used in the response generator 116 of the associated domain 110 to generate a response that gets sent to a client device in use by user 120.

It is a benefit of the present technology that the algorithms used in the respective response generators 116 are device-agnostic. That is, the software developers of the domain providers may provide the algorithms including synchronization statements described above without knowing the physical parameters of the devices which are to perform the actions. Each of these devices will properly synchronize audio with linked physical actions even though these devices possibly, even probably, will perform the physical actions at different speeds.

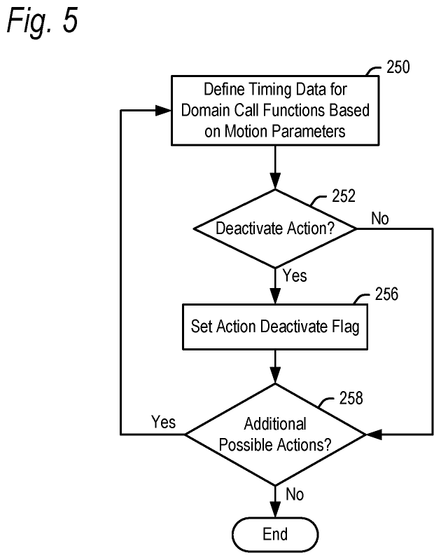

FIG. 5 is a flowchart setting forth the operation of the present technology at a client device 106. In step 250, a developer of a mechanical client device may specify timing data for each rotating or translating part in the client device. This timing data may for example describe how long it takes a part to translate or rotate through its full range of motion. This timing data may then be stored in memory of the client device, or uploaded to platform 102.

A software developer working with a computerized client device, having a graphical user interface and no moving parts, can skip step 250. However, in further embodiments, it may be that a software developer working with such a computerized client device may wish to emulate real-world motion in the characters displayed on the graphical user interface. In such embodiments, the software developer may go through step 250, using hypothetical timing data for the depicted rotational or translational motions.

It is conceivable that a developer of a client device may not wish to have the client device perform an action which is otherwise linked with certain audio. In step 252, the device developer chooses whether to deactivate (uncouple) otherwise linked physical movement. If not, the flow skips to step 258 to see if there are additional timing data values to add. On the other hand, if the developer wishes to deactivate a given action, an action deactivate flag is set in step 256.

In step 258, if the developer has additional actions to record timing data for, the flow returns to step 250. Otherwise, the flow ends. Developers of each of the client devices in communication with platform 102 may go through the steps of the flowchart of FIG. 5 to record the timing data for actual moving parts and/or virtual moving parts.

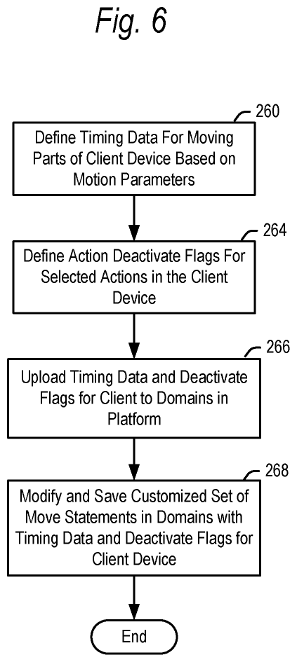

As explained below, the timing data may be used in function calls of the syntax statements received from the response generator 116 in real time. In particular, when a formatted response is sent from the platform 102 to a client device 106, the client device may execute the syntax statements, obtain the timing data of the function calls, and output the audio synchronized with the specified action. In further embodiments, once the timing data is obtained, it may be uploaded to the platform 102 to generate a set of move commands that is customized for that client device (i.e., the <move> syntax statements may be customized with the actual received timing data for a given client device). Such an embodiment will now be described with respect to the flowchart of FIG. 6.

In step 260, the timing data for actually or virtually moving parts of the client device may be defined for the motion parameters of that device as described above with respect to step 250 in FIG. 5. In step 264, action deactivate flags may be defined for selected actions in the client device as described above with respect to step 256 in FIG. 5.

In step 266, the identified timing data and deactivate flags for the client may be uploaded to the platform 102. The timing data and deactivate flags may be used within each domain 110 in step 268 to define a customized set of coding steps, including the actual timing data for the client device, to be used by the response generator 116. In a further embodiment, the timing data and deactivate flags may be uploaded and stored on the platform 102. Thereafter, when a response is generated from response generator 116, the function calls in the response may access the timing data and deactivate flags stored on the platform 102 for that client in real time, and then download the response to the client device.

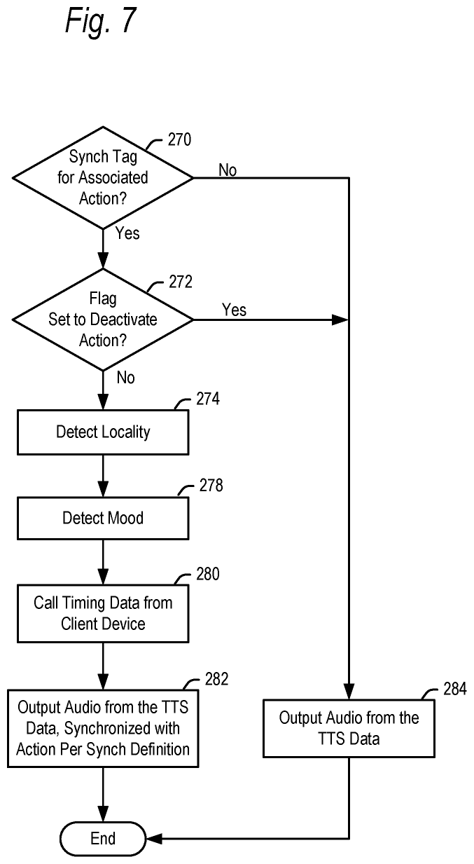

As described above, when content is received from a domain provider in response to a request for information, the response is generated in step 212 including the synchronized TTS and motion data statements, and then forwarded to the client device 106 for output. Further details of the operation of the client device in executing the response received from the response generator will now be described with reference to the flowchart of FIG. 7.

In step 270, a processor at the client device checks whether there is a synchronization tag linking motion data with TTS data received in the TTS data stream. If not, the flow skips to step 284 for the client device to synthesize speech from the TTS data. On the other hand, if a synchronization tag is found, the processor next checks in step 272 whether the client device has a deactivate action flag set for the identified linked motion. If so, the flow skips to step 284 for the client device to synthesize speech from the TTS data.

On the other hand, if no flag is detected in step 272, the processor may detect locality in step 274 and/or mood in step 278. Locality may be detected for example using GPS data in the client device. Mood may be detected in various known ways, such as for example recognizing speech. It is understood that the steps of detecting locality and/or mood may be omitted in further embodiments. Where omitted, the associated classifiers described above for locality and/or mood may also be omitted.

In step 280, a processor of the client device calls for the timing data recorded by a client device developer as described above with respect to FIGS. 5 and 6. It is understood that the step 280 may be skipped in the event the timing data has earlier been uploaded to the platform 102 (FIG. 6), and a response including syntax statements already customized with the timing data are sent from the response generator 116 to the client device 106. Using the timing data for that client device in the syntax statements included in the response from the response generator 116, the client device may output audio synchronized with an action for the synch definition in the syntax statements in step 282.

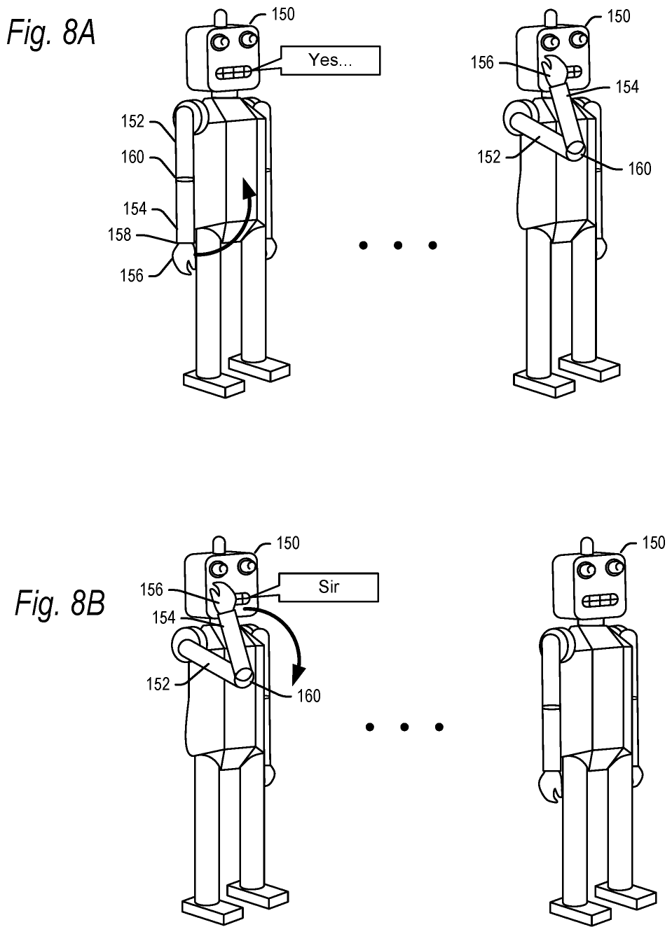

FIGS. 8A and 8B illustrate a robot 150 outputting audio and performing an action synchronized therewith as described above. In this example, the robot 150 includes an upper arm 152, a forearm 154, a hand 156, a wrist 158 and an elbow 160. Depending on the complexity of robot 150 the robot may include motorized joints at the wrist 158, elbow 160 and each of the moving fingers of hand 156. As described above, a developer of robot 150 may record timing data relating to the time it takes for the robot to bend the forearm 154 at elbow 160, the hand 156 at wrist 158 and the individual fingers of the hand 156.

The robot 150 may receive a response including syntax statements from the response generator 116 directing the robot to say “yes sir” in synchronization with a salute function and an at-ease function. Depending on how the synchronization tags are provided in the syntax statements, the robot may for example salute while saying the word “yes” (FIG. 8A), and return to at-ease at saying the word “sir” (FIG. 8B). As described above, the motions of the robot may be synchronized to the audio in different ways.

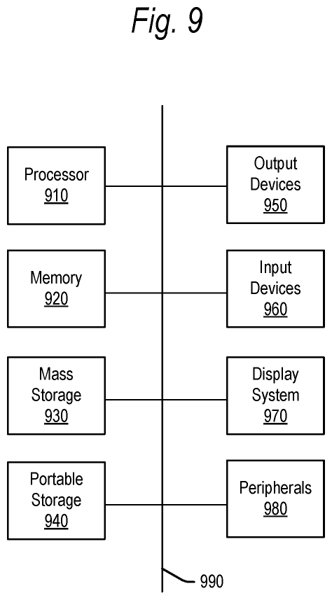

FIG. 9 illustrates an exemplary computing system 900 that may be used to implement an embodiment of the present invention. System 900 of FIG. 9 may be implemented in the context of devices at platform 102, domain providers 104 and/or client devices 106. The computing system 900 of FIG. 9 includes one or more processors 910 and main memory 920. Main memory 920 stores, in part, instructions and data for execution by processor unit 910. Main memory 920 can store the executable code when the computing system 900 is in operation. The computing system 900 of FIG. 9 may further include a mass storage device 930, portable storage medium drive(s) 940, output devices 950, user input devices 960, a display system 970, and other peripheral devices 980.

The components shown in FIG. 9 are depicted as being connected via a single bus 990. The components may be connected through one or more data transport means. Processor unit 910 and main memory 920 may be connected via a local microprocessor bus, and the mass storage device 930, peripheral device(s) 980, portable storage medium drive(s) 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 920.

Portable storage medium drive(s) 940 operate in conjunction with a portable non-volatile storage medium, such as a floppy disk, compact disk or Digital video disc, to input and output data and code to and from the computing system 900 of FIG. 9. The system software for implementing embodiments of the present invention may be stored on such a portable medium and input to the computing system 900 via the portable storage medium drive(s) 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Suitable output devices include speakers, printers, network interfaces, and monitors. Where computing system 900 is part of a mechanical client device, the output device 950 may further include servo controls for motors within the mechanical device.

Display system 970 may include a liquid crystal display (LCD) or other suitable display device. Display system 970 receives textual and graphical information, and processes the information for output to the display device.

Peripheral device(s) 980 may include any type of computer support device to add additional functionality to the computing system. Peripheral device(s) 980 may include a modem or a router.

The components contained in the computing system 900 of FIG. 9 are those typically found in computing systems that may be suitable for use with embodiments of the present invention and are intended to represent a broad category of such computer components that are well known in the art. Thus, the computing system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, the present technology relates to a system for synchronizing audio output with movement performed at a client device, the system implemented on a platform comprising one or more servers, and the system comprising: a memory; and a processor, the processor configured to execute instructions to: receive text to speech (TTS) data for audio output at the client device, receive movement commands for causing virtual or real movement at the client device, the movement commands not including timing data related to the virtual or real movement; and cause the transmission of the TTS data and movement commands to the client device to enable the client device to synchronize the audio output with the virtual or real movement at the client device, using timing data received at the client device related to the virtual or real movement.

In another example, the present technology relates to a system for synchronizing audio output with movement performed a client device performing real or virtual movements at different speeds, the system implemented on a platform comprising one or more servers, and the system comprising: memory; and a processor, the processor configured to execute instructions to: receive device-agnostic text to speech (TTS) data for audio output at the client device, receive device-agnostic movement commands for causing the virtual or real movement at the client device; and cause the transmission of the device-agnostic TTS data and movement commands to the client device to enable the client device to synchronize the audio output with the virtual or real movement at the client device, using timing data received at the client device related to the virtual or real movement.

In a further example, the present technology relates to a system for synchronizing audio output with movement performed at first and second client devices performing real or virtual movements at different speeds, the system implemented on a platform comprising one or more servers, and the system comprising: a memory; and a processor, the processor configured to execute instructions to: receive text to speech (TTS) data for audio output at the first and second client devices, receive movement commands for causing the virtual or real movement at the first and second client devices; and cause the transmission of the same TTS data and movement commands to the first and second client devices to enable the client devices to synchronize the audio output with the virtual or real movement at the client devices, using timing data received at the client devices related to the virtual or real movement.

In another example, the present technology relates to a client device for synchronizing audio output with movement performed at the client device, the client device comprising: a memory; and a processor, the processor configured to execute instructions to: receive text to speech (TTS) data for audio output at the client device, receive movement commands for causing virtual or real movement at the client device, the movement commands not including timing data related to the virtual or real movement; and synchronize the audio output with the virtual or real movement at the client device, using timing data at the client device related to the virtual or real movement.

In a still further example the present technology relates to a method of synchronizing audio output with movement performed at a client device, comprising: receiving device-agnostic text to speech (TTS) data for audio output at the client device; receiving device-agnostic movement commands for causing virtual or real movement at the client device; and causing the transmission of the TTS data and movement commands to the client device to enable the client device to synchronize the audio output with the virtual or real movement at the client device, using timing data received at the client device related to the virtual or real movement.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A client device for synchronizing audio output with movement performed at the client device, the client device comprising:
a memory; and
a processor, the processor configured to execute instructions to:
receive text to speech (TTS) data for audio output at the client device,
receive movement commands for causing virtual or real movement at the client device, the movement commands being device-agnostic; and
synchronize the audio output with the virtual or real movement at the client device, using timing data at the client device related to the virtual or real movement.

2. The client device of claim 1, wherein the client device synchronizes a beginning of the audio output with a beginning of the virtual or real movement at the client device.

3. The client device of claim 1, wherein the client device synchronizes an ending of the audio output with an ending of the virtual or real movement at the client device.

4. The client device of claim 1, wherein the client device slows one of the audio output and virtual or real movement to synchronize a beginning and ending of the audio output with a beginning and ending of the virtual or real movement at the client device.

5. The client device of claim 4, wherein slowing one of the audio output and virtual or real movement comprises slowing a motor affecting the movement in the client device.

6. The client device of claim 4, wherein slowing one of the audio output and virtual or real movement comprises slowing a speed at which the audio is output.

7. The client device of claim 1, wherein the client device synchronizes a beginning of a first portion of the audio output with a first portion of the virtual or real movement at the client device, and the client device synchronizes a beginning of a second portion of the audio output with a second portion of the virtual or real movement at the client device.

8. The client device of claim 1, wherein the processor and memory further receive a locality classification affecting synchronization of the audio output with the movement command at the client device.

9. The client device of claim 1, wherein the processor and memory further receive a mood classification affecting synchronization of the audio output with the movement command at the client device.

10. The client device of claim 1, wherein the client device is a mechanical device with moving parts.

11. The client device of claim 10, wherein the mechanical device comprises a motor, the timing data comprising an operating speed of the motor.

12. The client device of claim 10, wherein the mechanical device is a robot having at least at least one of limbs, hands and a facial feature.

13. The client device of claim 1, wherein the client device comprises a computer with a graphical display screen, the movement being virtual movement of a character displayed on the display screen.

14. A platform system for synchronizing audio output with movement performed at a client device, the system comprising one or more servers, and the system comprising:
a memory; and
a processor, the processor configured to execute instructions to:
receive device-agnostic text to speech (TTS) data for audio output at the client device,
receive device-agnostic movement commands for causing the virtual or real movement at the client device; and
cause the transmission of the device-agnostic TTS data and movement commands to the client device to enable the client device to synchronize the audio output with the virtual or real movement at the client device, using timing data available at the client device related to the virtual or real movement.

15. The platform system of claim 14, wherein causing the transmission of the TTS data and movement commands to the client device enables the client device to synchronize a beginning of the audio output with a beginning of the virtual or real movement at the client device.

16. The platform system of claim 14, wherein causing the transmission of the TTS data and movement commands to the client device enables the client device to synchronize an ending of the audio output with an ending of the virtual or real movement at the client device.

17. The platform system of claim 14, wherein causing the transmission of the TTS data and movement commands to the client device enables the client device to slow one of the audio output and virtual or real movement to synchronize a beginning and ending of the audio output with a beginning and ending of the virtual or real movement at the client device.

18. The platform system of claim 17, wherein slowing one of the audio output and virtual or real movement comprises slowing a motor affecting the movement in the client device.

19. The platform system of claim 17, wherein slowing one of the audio output and virtual or real movement comprises slowing a speed at which the audio is output.

20. The platform system of claim 14, wherein causing the transmission of the TTS data and movement commands to the client device enables the client device to synchronize a beginning of a first portion of the audio output with a first portion of the virtual or real movement at the client device, and enabling the client device to synchronize a beginning of a second portion of the audio output with a second portion of the virtual or real movement at the client device.

21. The platform system of claim 14, wherein the processor and memory further receive a locality classification and cause transmission of the locality classification to the client device, the locality classification affecting synchronization of the audio output with the movement command at the client device.

22. The platform system of claim 14, wherein the processor and memory further receive a mood classification and cause transmission of the mood classification to the client device, the mood classification affecting synchronization of the audio output with the movement command at the client device.

23. A method of synchronizing audio output with movement performed at a client device, comprising:
receiving device-agnostic text to speech (TTS) data for audio output at the client device;
receiving device-agnostic movement commands for causing virtual or real movement at the client device; and
causing the transmission of the TTS data and movement commands to the client device to enable the client device to synchronize the audio output with the virtual or real movement at the client device, using timing data received at the client device related to the virtual or real movement.
